(19) United States
(12) Patent Application Publication
(10) Pub. No.: US 2026/0359656 A1
(43) Pub. Date: Nov. 12, 2026

(54) LEARNING DEVICE, ESTIMATING DEVICE, LEARNING METHOD, ESTIMATING METHOD, AND PROGRAM

(71) Applicant: NTT, Inc., Tokyo (JP)

(72) Inventors: Yuki YAMANAKA, Musashino-shi, Tokyo (JP); Hiroyoshi TAKIGUCHI, Musashino-shi, Tokyo (JP); Masanori SHINOHARA, Musashino-shi, Tokyo (JP); Takuya MINAMI, Musashino-shi, Tokyo (JP); Yasunori WADA, Musashino-shi, Tokyo (JP); Yo KANEMOTO, Musashino-shi, Tokyo (JP); Hiroto NOMURA, Musashino-shi, Tokyo (JP)

(73) Assignee: NTT, Inc., Tokyo (JP)

(21) Appl. No.: 19/119,416

(22) PCT Filed: Nov. 2, 2022
(86) PCT No.: PCT/JP2022/041070

§ 371 Date: Apr. 9, 2025

(51) Int. Cl. G06N 3/094; G06V 10/72

(52) U.S. Cl. CPC G06N 3/094; G06V 10/72

(57) ABSTRACT

A learning device includes a memory and processing circuitry configured to acquire learning data, execute, for the learning data, predetermined conversion based on secret information, and execute learning of an estimation model on a basis of the learning data for which conversion has been executed.

### TECHNICAL FIELD

The present invention relates to a learning device, an estimation device, a learning method, an estimation method, and a program.

### BACKGROUND ART

With the spread of machine learning models, there have been reported a plurality of attacks for extracting information (for example, learning data) from learned models in operation, such as Model Inversion Attack, Membership Inference, and CopyCat CNN, and techniques for replicating models themselves. These attacks are a threat from the viewpoint of privacy protection and intellectual property protection.

### CITATION LIST

### Non Patent Literature

Non Patent Literature 1: Reza Shokri, et. al., “Membership Inference Attacks Against Machine Learning Models”, [online], [retrieved on Oct. 18, 2022], the Internet <URL:https://arxiv.org/abs/1610.05820>

Non Patent Literature 2: Somusho, AI model heno kougeki to sono taisakurei (in Japanese) (Ministry of Internal Affairs and Communications, Attacks on AI Models and Countermeasure Examples), [online], [retrieved on Oct. 18, 2022], the Internet <URL:https://www.mbsd.jp/aisec_portal/attack_model_inversio n.html>

### SUMMARY OF INVENTION

### Technical Problem

As countermeasures against these attacks, improvement of robustness of the models themselves, limitation of the number of queries to the machine learning models, addition of noise to information to be output from the models, and the like have been proposed, but none of them is a complete defense method.

The present invention has been made in view of the foregoing, and an object thereof is to provide a learning device, an estimation device, a learning method, an estimation method, and a program capable of reducing a risk of information leakage from a learned model of machine learning and a risk of replication of the model.

### Solution to Problem

To solve the above-described problem and achieve the object, a learning device according to the present invention includes: an acquisition unit configured to acquire learning data; a conversion unit configured to execute, for the learning data, predetermined conversion based on secret information; and a learning unit configured to execute learning of an estimation model on a basis of the learning data for which conversion has been executed by the conversion unit.

Furthermore, an estimation device according to the present invention includes: an acquisition unit configured to acquire data to be processed; a conversion unit configured to execute, for the data to be processed, predetermined conversion based on secret information; and an estimation unit configured to execute estimation processing on a basis of the data to be processed for which conversion has been executed by the conversion unit by using an estimation model for which learning has been executed on a basis of learning data for which the predetermined conversion based on the secret information has been executed.

### Advantageous Effects of Invention

According to the present invention, it is possible to reduce the risk of information leakage from a learned model of machine learning and the risk of replication of the model.

### BRIEF DESCRIPTION OF DRAWINGS

FIG. 1 is a diagram for describing an outline of processing in an embodiment.

FIG. 2 is a diagram illustrating an example of a configuration of a processing device according to an embodiment.

FIG. 3 is a diagram for describing an example of conversion processing executed by a conversion unit.

FIG. 4 is a diagram illustrating an example of a processing procedure of learning processing according to an embodiment.

FIG. 5 is a diagram illustrating an example of a processing procedure of estimation processing according to an embodiment.

FIG. 6 is a diagram illustrating an example of a computer on which the learning device is implemented by executing a program.

### DESCRIPTION OF EMBODIMENTS

Hereinafter, embodiments of a learning device, an estimation device, a learning method, an estimation method, and a program according to the present application will be described in detail with reference to the drawings. In addition, the present invention is not limited to the embodiment to be described below.

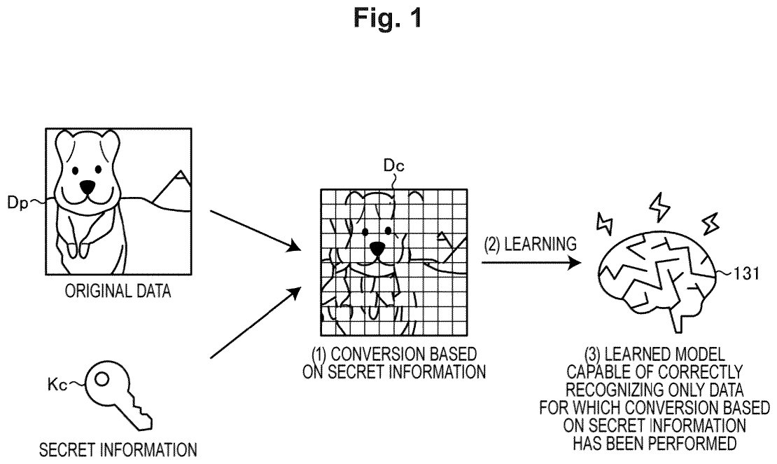

### Embodiment

[Outline of Processing of Embodiment] FIG. 1 is a diagram for describing an outline of processing in an embodiment. In a learning phase, first, conversion according to a specific rule based on secret information Kc is executed for learning data (for example, original data Dp) ((1) in FIG. 1).

Then, in the learning phase, learning of an estimation model 131 (machine learning model) is executed using only the learning data converted according to the rule ((2) in FIG. 1). As described above, in the embodiment, a learned model capable of correctly recognizing only data converted according to a specific rule based on secret information is generated ((3) in FIG. 1).

In an operation phase, data to be processed is converted according to the specific rule based on the secret information Kc, which is the same as the learning phase, and is then input to the estimation model 131, and estimation processing is performed. In this case, only a user or a device that has the secret information and can convert data according to the specific rule can use the estimation model 131 with high accuracy.

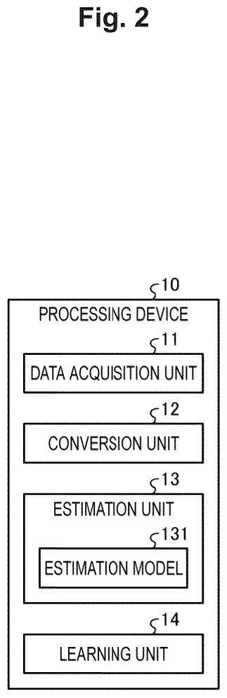

In other words, the estimation model 131 is only a model having insufficient detection accuracy and classification accuracy for data that is not converted on the basis of the secret information or data that has been converted according to a rule different from the specific rule, and is merely a model having no value for other users or devices.

[Processing Device] FIG. 2 is a diagram illustrating an example of a configuration of a processing device according to an embodiment. A processing device 10 is implemented by, for example, a predetermined program being read by a computer or the like including a read only memory (ROM), a random access memory (RAM), a central processing unit (CPU), and the like, and the CPU executing the predetermined program. In addition, the processing device 10 includes a communication interface that transmits and receives various types of information to and from another device connected via a network or the like.

The processing device 10 includes a data acquisition unit 11 (acquisition unit), a conversion unit 12, an estimation unit 13, and a learning unit 14.

The data acquisition unit 11 acquires data to be processed by the processing device 10. In the learning phase, the learning data is acquired. The learning data is, for example, a labeled image data set or a labeled table data set. In the operation phase, data to be processed in estimation processing is acquired. The data acquisition unit 11 acquires various data via, for example, a communication interface.

The conversion unit 12 executes predetermined conversion based on the secret information for the learning data or the data to be processed acquired by the data acquisition unit 11. The conversion unit 12 performs conversion according to the same rule based on the same secret information in the learning phase and the operation phase.

The secret information is, for example, a secret key stored in a module of the processing device 10. Specifically, the conversion unit 12 uses, for example, a secret key stored in a trusted platform module (TPM) or the like as the secret information. As a result, in the embodiment, it is possible to generate the estimation model 131 that operates only on a specific device with high accuracy.

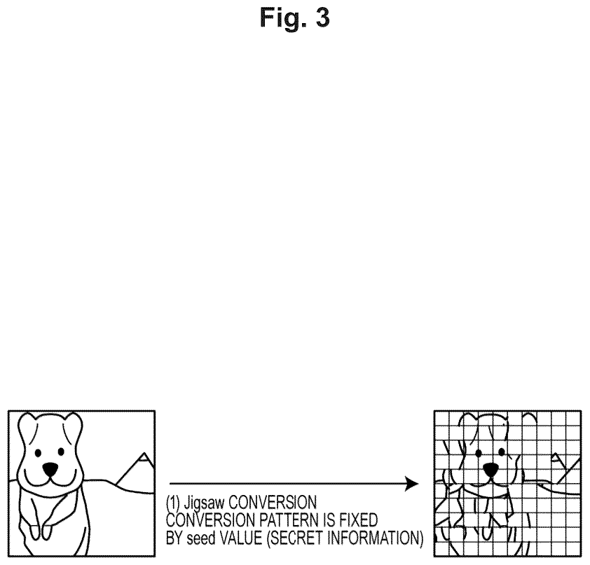

The predetermined conversion is conversion according to the specific rule. FIG. 3 is a diagram for describing an example of conversion processing executed by the conversion unit 12. As illustrated in FIG. 3, in a case where the data acquired by the data acquisition unit 11 is a labeled image data set (for example, Cifar10), the conversion unit 12 performs jigsaw conversion (Reference Literature 1) in which a conversion pattern is fixed by a seed value (secret information), for example. The jigsaw conversion is a conversion method of cutting an image into patches and then rearranging positions of the patches.

Reference Document 1: “aleju/imgaug”, [online], [searched on Oct. 28, 2022], Internet <URL:https://github.com/aleju/imgaug>

In a case where the data is image data, the conversion unit 12 may perform color tone conversion, affine transformation, or combination of two or more of the jigsaw conversion, the color tone conversion, and the affine transformation, using a conversion rule set using the secret information, in addition to the jigsaw conversion. For example, the color tone conversion is grayscale conversion of a color image. The affine transformation is transformation in which linear transformation such as rotation, scaling (enlargement or reduction), or skew, and translation are combined.

In a case where the data is table data, the conversion unit 12 performs shuffle of feature amounts, application of noise, or conversion combining the shuffling of feature amounts and the application of noise, using the conversion rule set using the secret information, for example. These conversion methods are examples, and the conversion unit 12 can apply various conversion methods in accordance with the type of data.

The estimation unit 13 executes estimation processing on the basis of the data for which conversion has been executed by the conversion unit 12, using the estimation model 131. The estimation model 131 is a machine learning model that performs predetermined estimation processing such as detection processing, classification processing, or collation processing when the data for which conversion has been executed by the conversion unit 12 is input, and outputs an estimation result.

In the learning phase, the estimation unit 13 inputs the learning data for which conversion has been executed by the conversion unit 12 to the estimation model 131, and outputs the estimation result output from the estimation model 131 to the learning unit 14.

In the operation phase, the estimation unit 13 inputs the data to be processed for which conversion has been executed by the conversion unit 12 to the estimation model 131, and outputs the estimation result output from the estimation model 131 to an output device, an external device, or the like. In the operation phase, the estimation model 131 for which learning has been executed on the basis of the learning data for which the predetermined conversion based on the secret information has been executed is used.

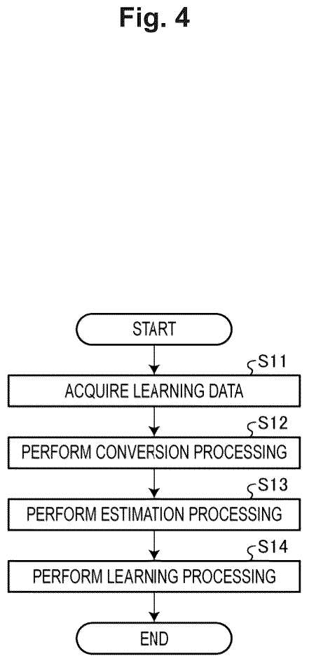

The learning unit 14 executes learning of the estimation model 131 on the basis of the learning data for which conversion has been performed by the conversion unit 12. The learning unit 14 executes learning of the estimation model 131, using machine learning such as supervised learning, unsupervised learning, reinforcement learning, or deep learning.

[learning Processing] Next, learning processing executed by the processing device 10 will be described. FIG. 4 is an example of a processing procedure of learning processing according to an embodiment.

As illustrated in FIG. 4, in the processing device 10, the data acquisition unit 11 acquires the learning data (step S11), and the conversion unit 12 executes the predetermined conversion based on the secret information for the learning data acquired in step S11 (step S12).

The estimation unit 13 executes the estimation processing on the basis of the learning data for which conversion has been executed by the conversion unit 12, using the estimation model 131 (step S13), and outputs the estimation result to the learning unit 14.

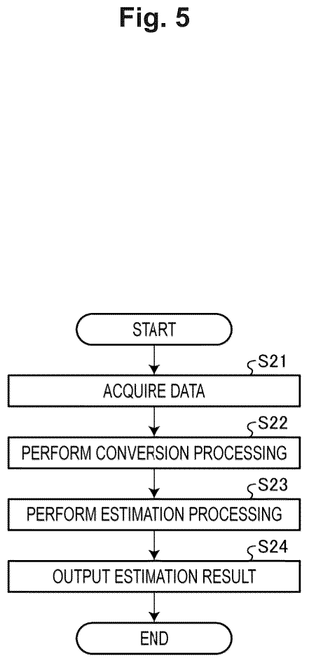

The learning unit 14 executes the learning processing for the estimation model 131 on the basis of the learning data for which conversion has been performed by the conversion unit 12 (step S14). For example, in a case where labeled learning data is used, the learning unit 14 optimizes parameters of the estimation model 131 so that the estimation result output from the estimation unit 13 in step S13 approaches a label of the learning data.

[Estimation Processing] Estimation processing executed by the processing device 10 will be described. FIG. 5 is an example of a processing procedure of estimation processing according to an embodiment.

In the processing device 10, the data acquisition unit 11 acquires the data to be processed (step S21), and the conversion unit 12 executes the predetermined conversion based on the secret information for the data to be processed acquired in step S21 (step S22).

The estimation unit 13 executes the estimation processing on the basis of the data to be processed for which conversion has been executed by the conversion unit 12, using the estimation model 131 (step S23). As illustrated in FIG. 4, the estimation model 131 is a model for which learning has been executed on the basis of the learning data for which the predetermined conversion based on the secret information has been executed. In the processing device 10, the estimation unit 13 outputs the estimation result (step S24), and terminates the estimation processing.

[Evaluation Experiment] An evaluation experiment of the processing device 10 was performed. In the evaluation experiment, a first convolutional neural network (CNN) model was generated by applying the learning method according to the embodiment. Specifically, the first CNN model was learned by using learning data obtained by performing first jigsaw conversion of the conversion pattern fixed by the seed value (secret information), for the labeled image data set Cifar10.

The classification accuracy of the first CNN model was 71.15% for first evaluation data for which the same first jigsaw conversion as that at the time of learning was performed.

Meanwhile, the classification accuracy of the first CNN model was 42.36% for second evaluation data for which the jigsaw conversion itself was not performed, and 41.00% for third evaluation data for which the jigsaw conversion of a pattern different from that of the first jigsaw conversion was performed.

Therefore, in the first CNN model, it can be seen that the classification accuracy of the second evaluation data and the third evaluation data is greatly deteriorated as compared with the classification accuracy of the first evaluation data.

As a result, it was experimentally confirmed that a model with insufficient accuracy can be generated for data for which the first conversion itself has not been performed or data for which the second conversion of a rule different from that of the first conversion has been performed by learning the machine learning model using only the data for which the predetermined conversion (first conversion) based on the secret information has been performed.

Note that, in a case where the classification accuracy was measured by using a second CNN model having the same configuration as the first CNN model used in the present evaluation experiment, in normal learning, that is, without performing any conversion for the learning data and without performing any conversion at the time of evaluation, the accuracy was 74.63%.

In the present evaluation experiment, a small model with a small number of parameters was used as the CNN model, and thus the accuracy is lower than that of general Resnet or the like, but it can be said that the accuracy (71.15%) of the first CNN model is close to the accuracy of the second CNN model. Therefore, accuracy degradation of the first CNN model is slight as compared with the second CNN model, and thus the first CNN model can also sufficiently cope with actual operation.

[Effects of Embodiment] As described above, in the processing device 10 according to the present embodiment, the estimation model 131 is learned using only the learning data for which the predetermined conversion based on the secret information has been executed. The predetermined conversion is conversion according to a specific rule using the secret information.

As also shown in the evaluation experiment, according to the processing device 10, only a user or a device that has the secret information and can convert data according to the specific rule can use the estimation model 131 with correct accuracy. That is, the estimation model 131 is merely a model having insufficient detection accuracy and classification accuracy for data that is not converted on the basis of the secret information or data that has been converted according to a rule different from the specific rule.

Therefore, the estimation model 131 is a valueless model for a user or device that does not have the secret information or a user or device that does not have the rule of data conversion.

Even if an attacker makes an attack (model inversion attack or membership inference) that extracts the learning data from the estimation model 131, it is difficult to accurately predict the original data from the converted data, and thus it is not worth making this attack. Further, similarly, even if the attacker makes an attack of extracting the parameters of the estimation model 131 or an attack of generating a replication model at the hand of the attacker, the model is merely a model with low accuracy for a user who does not have the secret information, and thus it is not worth stealing in the first place.

In the present embodiment, it is possible to reduce the risk of information leakage from the estimation model 131 and the risk of replication of the estimation model 131 by generating the estimation model 131 that is valuable for a user or a device that has the secret information and can convert data with the specific rule and is not valuable for a user or a device that does not have the secret information or a user or a device that does not have the rule of data conversion.

[System configuration of embodiment] The above-described each component of the processing device 10 illustrated in FIG. 1 is functionally conceptual, and does not necessarily need to be physically configured as illustrated. In other words, specific forms of distribution and integration of the functions of the processing device 10 are not limited to the illustrated forms, and all or some thereof can be functionally or physically distributed or integrated in arbitrary units according to various loads, usage conditions, and the like.

In addition, all or an arbitrary part of the processing performed in the processing device 10 may be implemented by a CPU and a program analyzed and executed by the CPU. Moreover, each processing performed in the processing device 10 may be implemented as hardware by wired logic.

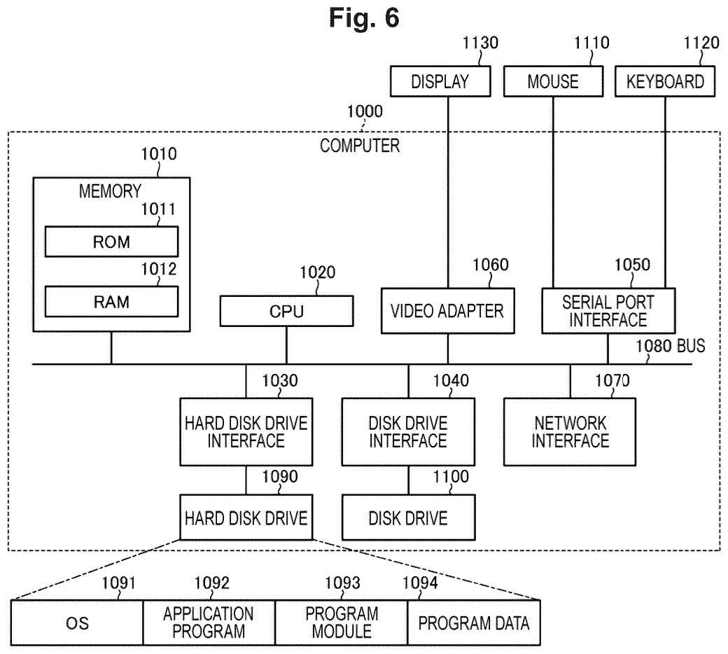

Further, among the processes described in the embodiment, all or part of the processes described as being automatically performed can be performed manually. Alternatively, all or part of the processing described as being manually performed can be automatically performed by a known method. In addition, the above-mentioned and shown processing procedures, control procedures, specific names, and information including various types of data and parameters can be appropriately changed unless otherwise specified.

[Program] FIG. 6 is a diagram illustrating an example of a computer in which a program is executed to implement the processing device 10. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a ROM 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, a program that defines each processing of the processing device 10 is implemented as the program module 1093 in which a code executable by the computer 1000 is described. The program module 1093 is stored in, for example, the hard disk drive 1090. For example, the program module 1093 for executing processing similar to the functional configurations in the processing device 10 is stored in the hard disk drive 1090. Note that the hard disk drive 1090 may be replaced with a solid state drive (SSD).

In addition, setting data used in the processing of the above-described embodiment is stored, for example, in the memory 1010 or the hard disk drive 1090 as the program data 1094. Then, the CPU 1020 reads the program module 1093 and the program data 1094 stored in the memory 1010 and the hard disk drive 1090 into the RAM 1012 as necessary, and executes the program module 1093 and the program data 1094.

The program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

While the embodiment to which the invention made by the present inventors is applied has been described above, the present invention is not limited by the description and the drawings constituting part of the disclosure of the above embodiment according to the present invention. In other words, other embodiments, examples, operation techniques, and the like made by those skilled in the art and the like on the basis of the present embodiment are all included in the scope of the present invention.

### REFERENCE SIGNS LIST

10 Processing device
11 Data acquisition unit
12 Conversion unit
13 Estimation unit
14 Learning unit
131 Estimation model

1. A learning device comprising:
a memory; and
processing circuitry configured to:
acquire learning data;
execute, for the learning data, predetermined conversion based on secret information; and
execute learning of an estimation model on a basis of the learning data for which conversion has been executed.

2. The learning device according to claim 1, wherein the secret information is a secret key stored in a module of the learning device.

3. The learning device according to claim 1, wherein the predetermined conversion is conversion according to a specific rule.

4. The learning device according to claim 3, wherein, in a case where the learning data is image data, the processing circuitry is further configured to perform jigsaw conversion, color tone conversion, affine transformation, or conversion combining two or more of the jigsaw conversion, the color tone conversion, and the affine transformation, and in a case where the learning data is table data, the processing circuitry is further configured to perform shuffle of feature amounts, application of noise, or conversion combining the shuffle of feature amounts and the application of noise.

5. (canceled)

6. A learning method executed by a learning device, the learning method comprising:
acquiring learning data;
executing, for the learning data, predetermined conversion based on secret information; and
executing learning of an estimation model on a basis of the learning data for which conversion has been executed.

7. (canceled)

8. A non-transitory computer-readable recording medium storing therein a learning program that causes a computer to execute a process comprising:
acquiring learning data;
executing, for the learning data, predetermined conversion based on secret information; and
executing learning of an estimation model on a basis of the learning data for which conversion has been executed.
